(19) United States
(12) Patent Application Publication
(10) Pub. No.: US 2007/0250543 A1
(43) Pub. Date: Oct. 25, 2007

(54) Differential data managing apparatus

(75) Inventor: Takenori Ichinose, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/786,843

(22) Filed: Apr. 12, 2007

(30) Foreign Application Priority Data
Apr. 24, 2006 (JP) 2006-118643

(51) Int. Cl. G06F 17/30

(52) U.S. Cl. 707/200

(57) ABSTRACT

A differential data managing apparatus includes: a comparison display section which displays data items in each of databases in a tree structure, and displays the data items that are different with each other between the databases as differential data items distinguishably from the other data items; Portable Document Format (PDF) generation section which generates detailed PDF files from detailed data in each of the databases, the detailed data related to the data items being selected from the differential data items; and a differential PDF generation section which acquires the generated detailed PDF files, and generates a differential PDF file in which a difference between the generated detailed PDF files are converted into image information.

This application claims foreign priority based on Japanese Patent application No. 2006-118643, filed Apr. 24, 2006, the content of which is incorporated herein by reference in its entirety.

### BACKGROUND OF THE INVENTION

1. Field of the Invention

The present invention relates to a differential data managing apparatus for comparing data of databases, and extracting and outputting (display/print) a difference between the data of the databases.

2. Description of the Related Art

FIG. 7 is a functional block diagram showing an exemplary configuration of a distributed control system to which an engineering station including a related art differential information display section is connected. An operation monitoring apparatus 1 of the distributed control system is connected to a control bus 2.

A controller 3 connected to the control bus communicates with the operation monitoring apparatus 1 as well as with devices 51, 52, . . . , 5n of a plant 5 via a field bus 4, and executes an application program 31 and controls these devices.

An engineering station 6 for generating an operation monitoring program to be executed in the operation monitoring apparatus 1 and the application program 31 to be executed in the controller 3 is connected to the control bus 2.

In the engineering station 6, engineering data generated in a builder 61 is held in an engineering database 62 (hereinafter, referred to as the DB1), and copied to a master database 63 (hereinafter referred to as the DB2) to be held therein.

The engineering data being engineered and held in the DB1 is downloaded to an application database 32 (hereinafter referred to as the DB3) of the controller 3, via a download processing section 65 based on an instruction from a download instruction section 64 and also via the control bus 2. In this state, the engineering data held in the DB2 reflects the engineering data in the DB3 downloaded from the DB1 just before.

After that, when it is desired to change the contents of the DB1 in the engineering process and to download the changed data to the DB3, there is a request to check the changes based on the comparison between the current engineering data and the engineering data previously downloaded.

Purposes of checking the changes are:

(1) To check whether the database after the engineering process includes only the intended changes. This purpose includes a case where a check is made to ensure that the database has not been tampered by a malicious person while the engineer has left the engineering station.

### (2) To check the difference between the database under operation and the database under engineering.

### (3) A client has requested modification of engineering data, and it is necessary to prove the difference between the engineering database before modification and the engineering database at the delivery.

### (4) To recognize the change history between versions in a database whose backup is created for version management.

A difference extracting section 66 of the engineering station 6 compares, based on a signal from the download instruction section 64, the engineering data in the DB1 that has been engineered and the engineering data in the DB2 that reflects the engineering data in the DB3 being downloaded from the DB1 just before, and extracts differential items, before download to the DB3 is performed.

The extracted differential items are sent to a differential information display section 67 to be displayed. An engineer can check the changed items by way of this display. FIG. 8 is an example of a display screen of the differential information display section 67.

This screen displays only the items of engineering data that has been changed. To check detailed data of the changed data items, it is necessary to access the contents of the DB1 and the DB2 based on this changed item information and print out the details of the changed contents to visually compare and review.

JP-A-9-81427 describes an apparatus for creating a program that extracts the updated differential data in a database.

Differential data management function provided in a related art engineering station has the following problems:

### (1) Only the items are displayed for the differential information display, so that it is necessary to perform complicated processes such as an access to a database and printout, for checking the detailed information.

(2) Since details of difference are not presented visually, an engineer having special knowledge for analysis of difference is required. Further, a considerable time is required, and there is a possibility of analysis errors such as overlooking the differential points.
(3) The changed data is not outputted in a print format that can be issued as a document to prove the modifications to the client. Thus, the document has to be separately prepared offline. This work is complicated and requires a lot of time and human operation, thus assurance of reliability is weak.

### SUMMARY OF THE INVENTION

The present invention has been made in view of the above circumstances, and provides a differential data managing apparatus capable of outputting details of differential data between databases under comparison visually and automatically without complicated operation.

In some implementations, a differential data managing apparatus of the invention, comprising:

a comparison display section which displays data items in each of databases in a tree structure, and displays the data items that are different with each other between the databases as differential data items distinguishably from the other data items;

a portable document format (PDF) generation section which generates detailed PDF files from detailed data in each of the databases, the detailed data related to the data items being selected from the differential data items; and

a differential PDF generation section which acquires the generated detailed PDF files, and generates a differential PDF file in which a difference between the generated detailed PDF files are converted into image information.

In the differential data managing apparatus, the differential PDF generation section outputs the generated differential PDF file to at least one of a display, a printing section and a file output section.

In the differential data managing apparatus,

one of the databases is an engineering database storing engineered data to be downloaded to an application database, and

the other is a master database that reflects contents of the application database.

In some implementations, a system of the invention comprising:

the differential data managing apparatus; and

a controller which controls devices in a plant and has the application database.

In some implementations, a system of the invention comprising:

the differential data managing apparatus; and

a safety controller which has the application database, and acquires trip information from a device in a plant and executes shutdown operation of the plant.

In the differential data managing apparatus, the databases include any two databases among a plurality of databases whose backups are created for version management.

### BRIEF DESCRIPTION OF THE DRAWINGS

FIG. 1 is a functional block diagram showing an embodiment of a differential data managing apparatus to which the invention is applied.

FIG. 2 is a conceptual view of a differential data managing environment provided by the invention, from a viewpoint of an engineer.

FIG. 3 is a transition diagram showing the flow of data processing to provide the environment of FIG. 2.

FIG. 4 is a dialog screen for specifying comparison object databases that is displayed upon activation.

FIG. 5 a main window screen which displays the item whose difference is detected in a different background color.

FIG. 6 is a differential detailed information display screen popped up to be displayed on the main window.

FIG. 7 is a functional block diagram showing an exemplary configuration of a distributed control system to which an engineering station including a related art differential information display section is connected.

FIG. 8 is an example of a display screen of a related art differential information display section.

### DESCRIPTION OF THE PREFERRED EMBODIMENTS

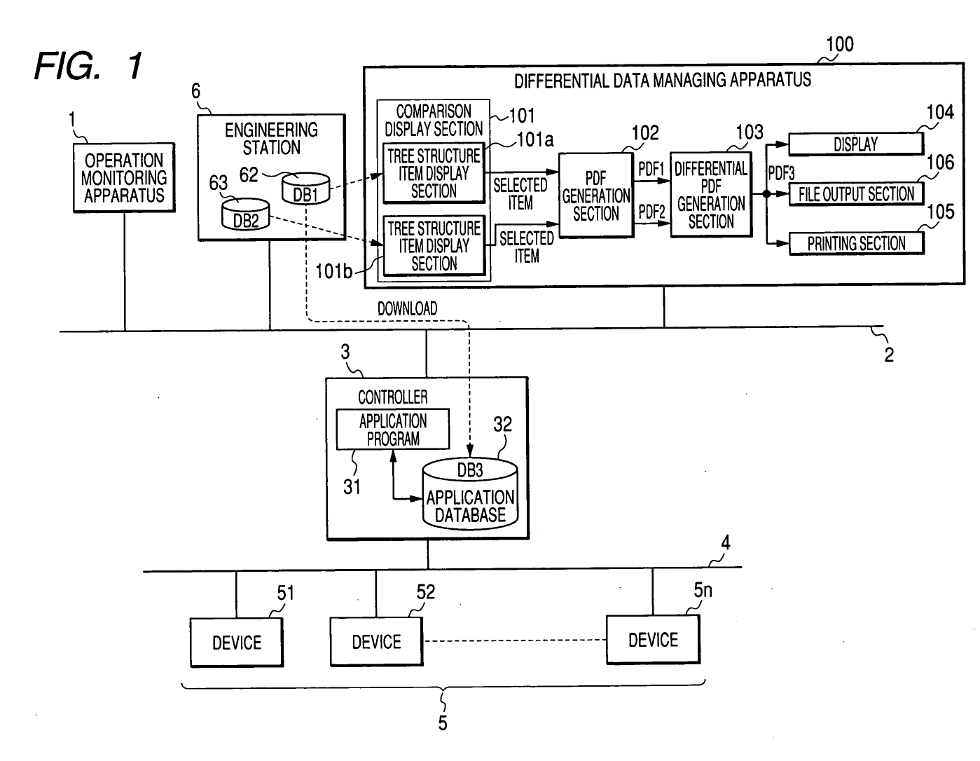

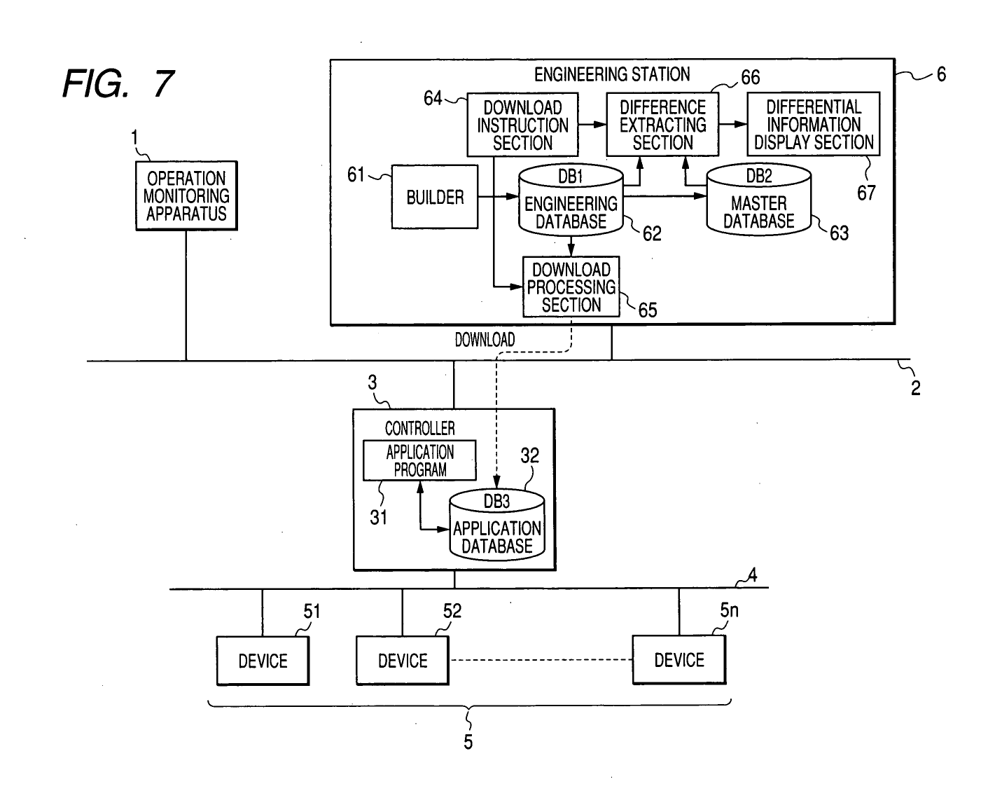

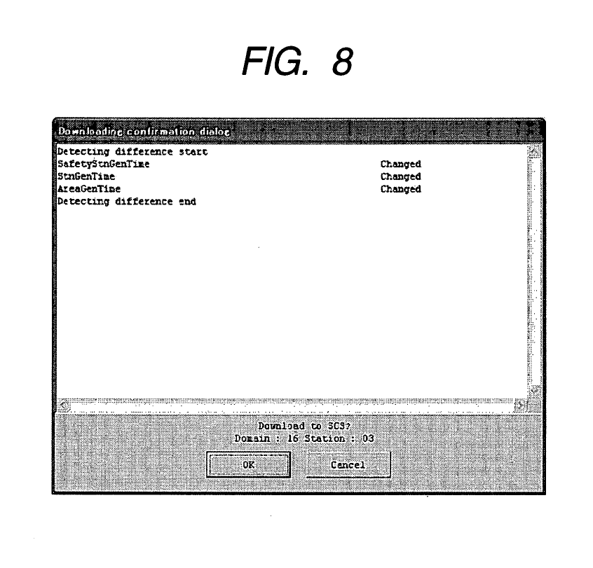

The invention will be described in detail referring to drawings. FIG. 1 is a functional block diagram showing an embodiment of a differential data managing apparatus to which the invention is applied. Components same as those described referring to FIG. 7 are given the same reference numerals, and corresponding description is omitted.

In the embodiment shown in FIG. 1, a differential data managing apparatus 100 of a standalone PC (personal computer) is connected to the control bus 2 of the distributed control system to which the engineering station 6 is connected.

In the differential data managing apparatus 100, a comparison display section 101 includes two tree structure item display sections 101a and 101b, each of which displays formation, which is specified by a user, of each of the two databases in a tree structure.

In this embodiment, the tree structure item display section 101a displays the formation of the database DB1 in the engineering station 6, while the tree structure item display section 101b displays the formation of the database DB2.

The tree structure item display sections 101a and 101b compare the databases for respective items based on menu selection from the screen, and displays the items having differences (differential items) in a different color on the tree structure. Note that, at this point of time, although it is known that the item has a difference, it is not known which data is different specifically.

To display and print out detailed differential information, an engineer clicks the item displayed in a different color on the tree structure display screen, to select the item. This item selection information is sent to a PDF generation section 102. Then, detailed PDF files that reflect details of data included in the selected item in the comparison object databases DB1 and DB2, PDF1 and PDF2, are generated and outputted.

The PDF (Portable Document Format), a standard proposed by Adobe Systems Incorporated, is now an industry standard. Software products for creating PDF are available from various companies. Such a product may be used as the PDF generation section 102.

A differential PDF generation section 103 acquires PDF1 and PDF2 outputted from the PDF generation section 102, compares the data in PDF1 and PDF2 included in the selected item, extracts the difference, and generates and outputs a differential PDF file PDF3 in which the difference is converted into an image display.

In this way, as a commercial software product having a function to compare two PDFs, extract differential data and generate a PDF including image information converted from the differential data, Acrobat from Adobe Systems Incorporated may be used as the differential PDF generation section 103.

The differential PDF generation section 103 sends the generated PDF3 to at least one of a display 104, a printing section 105 and a file output section 106 to perform display, printing or file saving operation.

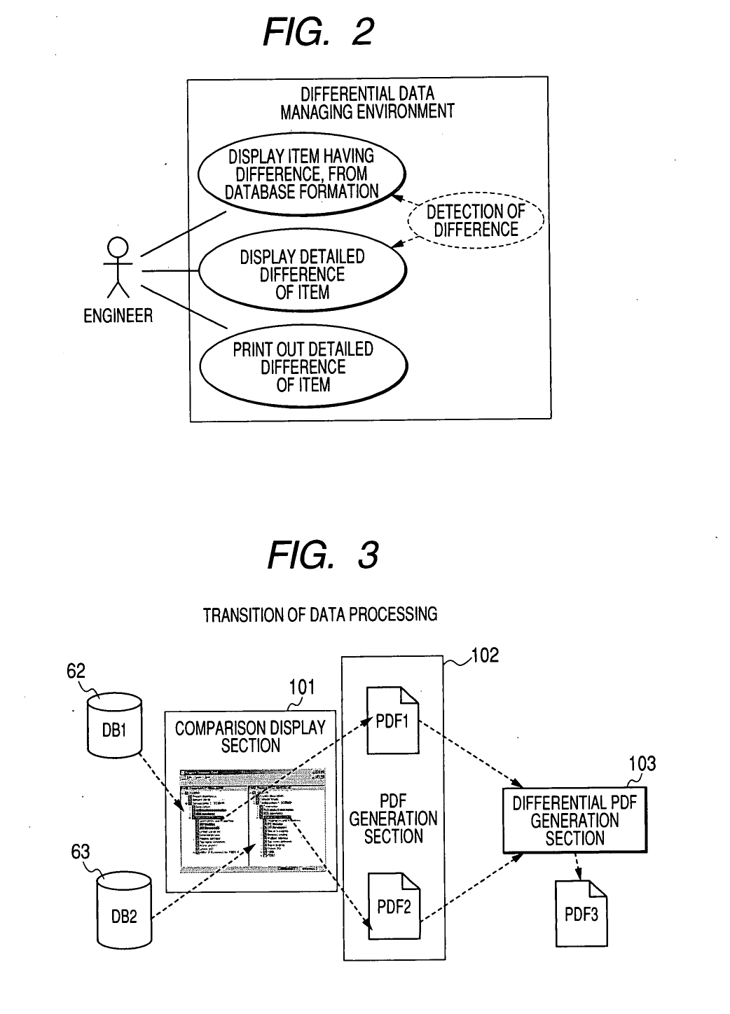

FIG. 2 is a conceptual view of a differential data managing environment provided by the invention, from a viewpoint of an engineer. According to the embodiment of the invention, the engineer is able to obtain an environment where the display of an item having a difference, display of details of difference in the item, and printing of the details of difference in the item can be automatically performed simultaneously.

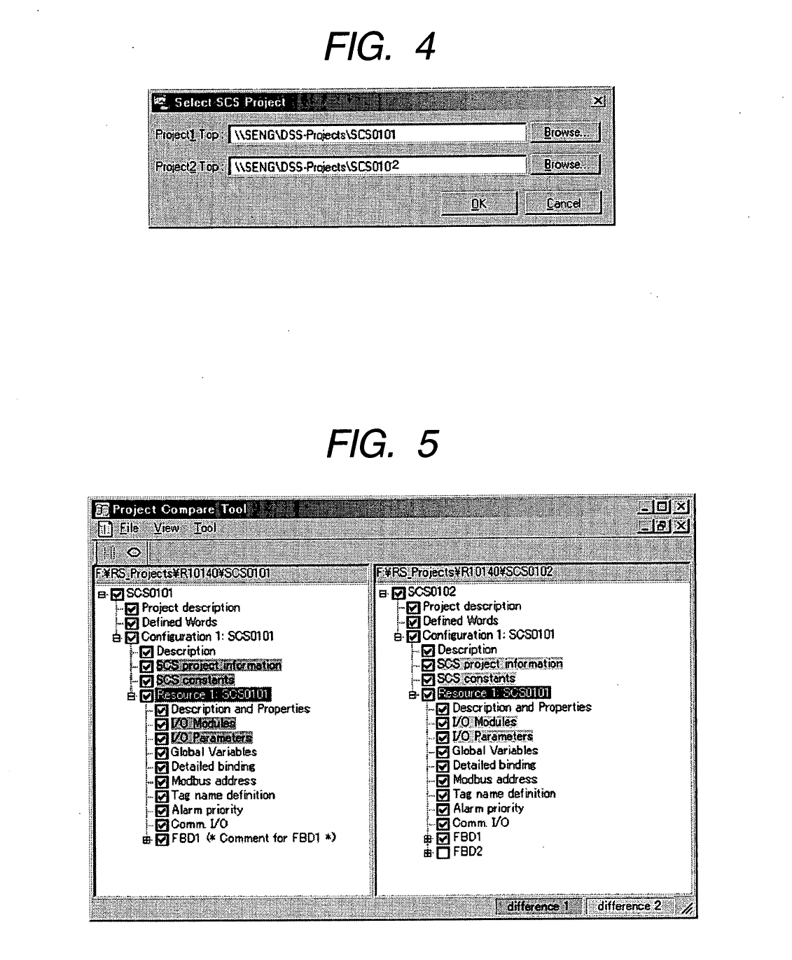

FIG. 3 is a transition diagram showing the flow of data processing of the embodiment of the invention to provide the environment of FIG. 2. On the screen of the comparison display section, formations of the two databases are displayed in parallel in a tree structure, and the item having differential data is identified in a different color to be displayed.

In the screen selection of the item for which details of the differential data are to be displayed, PDF1 and PDF2 reflecting the details of data included in the selected item are automatically generated. Further, PDF3 reflecting the differential data between the two PDFs is automatically generated.

Operation of the differential data managing apparatus and an example of the displayed screen will be described referring to FIGS. 4 to 6. FIG. 4 is a dialog screen for specifying comparison object databases that is displayed upon activation of the differential data managing apparatus. The comparison object databases are selected from this screen.

A main window screen is displayed when the user specifies comparison object databases on the dialog screen of FIG. 4 and presses an OK button. Data formation in each database is displayed in parallel in a tree structure. At this point of time, the detection and display of an item having a difference is not performed.

An engineer selects the item to perform comparison and selects a menu for detection of difference. Then, difference for every selected item is detected, and the item whose difference is detected is displayed in a different background color as shown in FIG. 5. The engineer identifies an item displayed in a different background color to readily grasp which item has difference.

At this point of time, it is known that the item has difference but it is not known which part of the engineering data includes difference. To identify this, the detailed difference must be displayed or printed.

To display the detailed difference, the engineer selects on the screen the item whose difference is detected, and selects a menu for displaying the detailed difference. By this selection, the differential PDF file PDF3 is automatically prepared, and popped up to be displayed as a new document window on the main window.

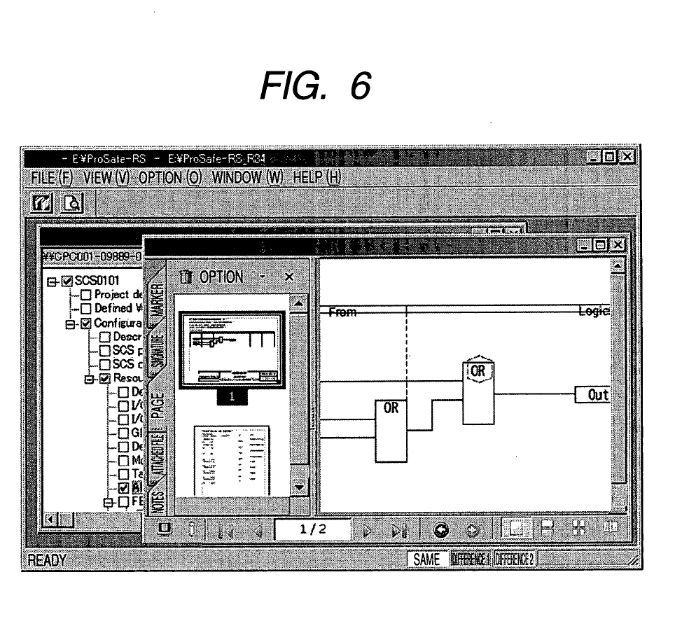

FIG. 6 is a differential detailed information display screen by the differential PDF file PDF3 that is popped up on the main window. In this display example, the differential section of a ladder program is displayed so as to be surrounded by a hexagonal frame thus the engineer readily can identify the modified section in engineering.

The document window showing the detailed difference includes a print menu. By selecting the print menu, the modified section can be printed out. The printed document may be used as an official document for notifying a client of modifications.

In this invention, databases as the comparison objects are not limited to those in the engineering station, but may be the database on the hard disk of a user's PC or on the readable hard disk of another PC.

In an embodiment where databases as the comparison objects are limited to those in the engineering station, the function of the differential data managing apparatus 100 provided by a standalone PC shown in FIG. 1 may be implemented in the engineering station 6.

With a combination of the invention and a plurality of databases whose backups are created for version management, or an application for reconstruction of a master database, it is possible to add a difference detecting function to the respective functions.

As understood from the above, the invention offers the following advantages:

(1) The data items of the comparison object databases are displayed in parallel in a tree structure, and the item is selected from the screen after identifying the items having differences by a background color. Then, detailed information of the selected items is automatically converted into PDF. Therefore, complicated processing such as an access to a database or printout for checking the detailed information is no longer required.

Accordingly, it becomes easy to avoid a risk that an engineering error is sent to a controller, thus ensuring safe operation. It is also made easy to check that the database has not been tampered by a malicious person while the engineer has left the engineering station.

(2) A differential PDF is automatically generated based on the two detailed PDFs, and the details of the difference are displayed and/or printed visually. Therefore, an operator having special knowledge for analysis of difference is not required, and there is no risk of analysis error.

(3) The printout of the differential PDF serves as a document to prove the modifications to the client. Thus, it is not necessary to separately prepare the document offline. The complicated work that requires a lot of time is no longer required, and no human operation is required either, which greatly assures reliability of the document.

### (4) The efficiency of work to recognize the change history between each of the databases whose backups are created for version management is enhanced.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A differential data managing apparatus, comprising:
a comparison display section which displays data items in each of databases in a tree structure, and displays the data items that are different with each other between the databases as differential data items distinguishably from the other data items;
a portable document format (PDF) generation section which generates detailed PDF files from detailed data in each of the databases, the detailed data related to the data items being selected from the differential data items; and
a differential PDF generation section which acquires the generated detailed PDF files, and generates a differential PDF file in which a difference between the generated detailed PDF files are converted into image information.

2. The differential data managing apparatus according to claim 1, wherein the differential PDF generation section outputs the generated differential PDF file to at least one of a display, a printing section and a file output section.

3. The differential data managing apparatus according to claim 1,
wherein one of the databases is an engineering database storing engineered data to be downloaded to an application database, and
the other is a master database that reflects contents of the application database.

4. A system, comprising:
the differential data managing apparatus according to claim 3; and
a controller which controls devices in a plant and has the application database.

5. A system, comprising:
the differential data managing apparatus according to claim 3; and
a safety controller which has the application apparatus, and acquires trip information from a device in a plant and executes shutdown operation of the plant.

6. The differential data managing apparatus according to claim 1, wherein the databases include any two databases among a plurality of databases whose backups are created for version management.
